(19) United States
(12) Patent Application Publication
(10) Pub. No.: US 2025/0391029 A1
(43) Pub. Date: Dec. 25, 2025

(54) COMPUTER-IMPLEMENTED METHOD FOR SEGMENTATION AND EXTRACTION OF TOPOLOGICAL NETWORK OF FRACTURES IN SEISMIC ATTRIBUTES

(71) Applicants: PETRÓLEO BRASILEIRO S.A. – PETROBRAS, Rio de Janeiro (BR); UNIVERSIDADE DO VALE DO RIO DOS SINOS - UNISINOS, São Leopoldo (BR)

(72) Inventors: Delano MENECUCCI IBANEZ, Rio de Janeiro (BR); Nayguel De Castro COSTA, Rio de Janeiro (BR); Anderson MORAES, Rio de Janeiro (BR); Nolan Maia DEHLER, Rio de Janeiro (BR); Ademir MARQUES JUNIOR, São Leopoldo (BR); Mauricio ROBERTO VERONEZ, São Leopoldo (BR); Luiz Gonzaga DA SILVEIRA JUNIOR, São Leopoldo (BR); Leandro TONIETTO, São Leopoldo (BR); Rodrigo BAZO, São Leopoldo (BR)

(21) Appl. No.: 19/201,252

(22) Filed: May 7, 2025

(30) Foreign Application Priority Data
Jun. 20, 2024 (BR) 1020240126637

(51) Int. Cl. G06T 7/11; G01V 1/30; G01V 1/34; G06T 3/40; G06T 7/12; G06T 7/136; G06T 7/162; G06T 7/187; G06V 10/44

(52) U.S. Cl. CPC G06T 7/11; G01V 1/306; G01V 1/345; G06T 3/40; G06T 7/12; G06T 7/136; G06T 7/162; G06T 7/187; G06V 10/457; G01V 2210/646; G06T 2207/20016; G06T 2207/20044; G06T 2207/30181

(57) ABSTRACT

The proposed technique introduces embodiments of a computer-implemented method for interpreting image delineations as vector objects and topological extraction from segmentation by visual computational methods applied to sections (slices) of seismic volumes, in order to aid geological interpretation and sampling of parameters originating from the fracture network and its topology. Embodiments of a developed method integrates a software/application that allows the loading and generation of statistical data related to the fracture network while maintaining georeferencing and scale of the two-dimensional input data. In addition, a fracture segmentation method is shown that uses pyramid image smoothing (decomposition into hierarchical levels of resolution) in order to reduce the amount of details and aid the identification of main faults or fractures. The segmentation after this smoothing is based on adaptive thresholding segmentation.

### FIELD OF THE DISCLOSURE

The present disclosure is related to an algorithm for interpreting lineaments in the image as vector objects and topological extraction from segmentation by visual computational methods applied to sections (slices) of seismic volumes, in order to assist the geological interpretation and sampling of parameters originating from the fracture network and its topology.

### BACKGROUND OF THE DISCLOSURE

The interpretation of fractures and faults is of great importance in estimating fluid flow in hydrocarbon reservoirs, as they influence the porosity and permeability properties of the rock matrix. The presence of faults or high porosity or permeability of the rock medium indicates regions of possible ease of flow. This interpretation or characterization of the fracture network can be performed through digital representations in seismic models and remote sensing images, either manually or with computer assistance. It can also be done directly in the field when considering analogous outcrops. Manual interpretation is often costly and requires many hours of work and can also be influenced by the subjective bias of each specialist. Fracture segmentation and characterization techniques aim to accelerate this process and can serve as a basis for extracting statistics from more complex fracture networks, or as an initial reference for interpretation by the specialist. There are previous studies on the identification of fractures in vertical seismic data and in images of horizontal and vertical outcrops, but not in horizontal seismic images, known as slices. Slices are similar to maps, which are the main tool for regional structural analysis and for understanding the flow and its relationship with the fault network at the reservoir scale. Furthermore, computational resources can assist in the sampling and extraction of statistics relevant to reservoir modeling, such as obtaining geometric (direction, length), topological (identification of junctions, bifurcations, terminations and connectivity indices) and mechanical (roughness) information.

### STATE OF THE ART

The document WO 03052458 A1, entitled “Process for interpreting faults from a fault-enhanced 3-dimensional seismic attribute volume”, discloses a computer-implemented method (FIG. 1) for interpreting faults from a fault-enhanced 3-D seismic attribute cube. The method includes the steps of extracting faults from a 3-D seismic attribute cube and calculating a minimum path value for each voxel of the 3-D seismic attribute cube. A fault network skeleton is extracted from the 3-D seismic attribute cube using the minimum path values that correspond to the voxels within the 3-D seismic attribute cube. The individual fault networks are then labeled, and a vector description of the fault network skeleton is created. The fault network skeleton is subdivided into individual fault patches, where individual fault patches are the smaller, non-intersecting, non-bifurcating patches that lie on a single fault line. The individual fault patches are then correlated into a fault representation.

More specifically, the document WO 03052458 A1 is directed to a semi-automatic process for interpreting faults from a fault-enhanced 3-D seismic attribute cube. The process operates in three dimensions on time groups or horizontal slices across the 3-D seismic cube. Faults in the input data are represented by the upper or lower bound of the seismic attribute range. As shown in FIG. 1, the overall process for interpreting faults from a fault-enhanced 3-D seismic attribute cube has five distinct processing steps. The first four steps are automatic. The last step is semi-automatic.

The document CN 114252913 A, entitled “Method and device for identifying plane fault information”, discloses a method and device for identifying plane fault information, and the method comprises the steps: obtaining the initial slice image data of a third-generation coherent attribute target layer from a three-dimensional seismic data body of a predetermined region, and making the initial slice image data have fault information; performing median filtering processing on the initial slice image data, and determining difference image data between the slice image data after median filtering processing and the initial slice image data; performing histogram equalization processing and threshold adjustment processing on the difference image data to enhance fault information; and identifying fault information in the initial slice image data according to the image data after enhancing fault information. Through the method, the quality of the seismic data can be improved and the difference between the local fault area and the background value is increased, so that the accuracy of fault identification can be improved.

The document CN 114252913 A also discloses a device for identifying plane fault information, the device comprising: a data acquisition unit configured to acquire initial slice image data of a third-generation coherent attribute target layer of a three-dimensional seismic data volume in a predetermined area. The initial slice image data has tomographic information; a median filter unit is used to perform median filter processing on the initial slice image data; a difference data determination unit is used to determine the slice image data after median filter processing and the slice image data difference between the initial image data of the slices; an equalization processing unit for performing histogram equalization processing and threshold adjustment processing on the difference image data to enhance tomographic information; an identification unit according to the tomographic information. The enhanced image data identifies slice information in the original slice image data.

### SUMMARY OF THE DISCLOSURE

The present disclosure is applied to two-dimensional data, such as outcrop images and seismic volume slices, resulting in an interpretation of the fracture network and its topological elements, as well as sample statistics on geometric and topological attributes of the fracture network. Due to the great variability of fractured outcrops and seismic elements, the solution proposed here allows the definition of parameters that fit each situation, especially when using seismic data pre-processed by other algorithms, ensuring that it is possible to extract fracture interpretations according to the analysis of the user. The automated processing nature with the possibility of user intervention/customization (called assisted mode) is the main problem that the disclosure solves: integrated time for entirely manual interpretation and extraction of statistics and diagrams relevant to reservoir characterization. This is guaranteed through the development of fracture segmentation techniques and characterization of the topological network and its statistics. Fracture segmentation is based on image processing techniques that do not depend on prior learning and creation of databases (datasets), while a visual interface helps the user customize the process by adjusting parameters. It is important to highlight that georeferencing information is respected, ensuring the superposition of the identified fractures on the input model (seismic or outcrop image).

### BRIEF DESCRIPTION OF THE DRAWINGS

The present disclosure will be described below reference to its typical embodiments and also with reference to the attached drawings.

FIG. 1 is a flowchart representing the steps of the method according to an embodiment of the present disclosure.

FIG. 2 is a representation of the steps performed for topology extraction according to an embodiment of the present disclosure.

FIG. 3 is an exemplary representation of file types used as input data considering a single seismic horizon, according to an embodiment of the present disclosure in operation.

FIG. 4 is a summarized representation of the results of steps 1, 2 and 3 of the method of an embodiment of the present disclosure.

FIG. 5 is a representation of the expected fracture statistics results after segmentation and extraction of the fracture network according to an embodiment of the present disclosure.

FIG. 6 is an exemplary representation of a user interface that allows the user to adjust parameters for implementing the method according to an embodiment of the present disclosure.

### DETAILED DESCRIPTION OF THE DISCLOSURE

Specific embodiments of the present disclosure are described below. In an effort to provide a concise description of these embodiments, all features of an actual implementation may not be described in the specification. It should be appreciated that in the development of any actual implementation, as in any engineering or design project, numerous implementation-specific decisions must be made to achieve the specific goals of the developers, such as compliance with system-related and business constraints, which may vary from one implementation to another. Furthermore, it should be appreciated that such a development effort may be complex and time-consuming, but would nevertheless be a routine design, manufacturing, and manufacturing undertaking for those of ordinary skill having the benefit of this disclosure.

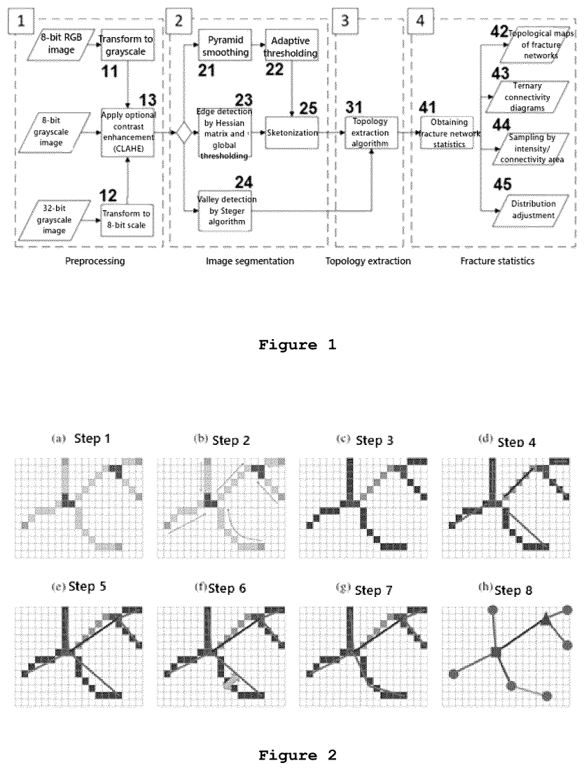

The present disclosure consists of a method for interpreting fractures and faults in horizontal seismic images, known as slices, to obtain statistics from a fracture network. The method of the present disclosure comprises four steps, each comprising several steps. The first step is image pre-processing, which is an optional step. The second step consists of image segmentation techniques, while the third step performs topology extraction using a specialized algorithm and, finally, the fourth step consists of steps to obtain fracture statistics from the analyzed slices. These steps will be explained in detail below, with reference to FIG. 1.

### First Step (Optional)—Pre-Processing 1

In the first step, horizontal seismic or horizontal outcrop data are loaded in the form of two-dimensional images, in order to maintain georeferencing data.

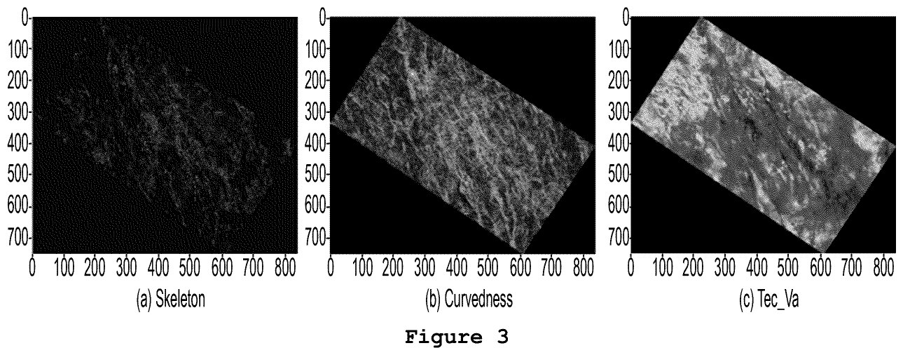

These data, originating from processing that aims to highlight specific attributes of the seismic data, are exemplified in FIG. 3, which demonstrates the visual characteristics of each of these types of data.

For the method of the present disclosure, said two-dimensional images must be in grayscale and in 8-bit resolution. Images in other color scales, for example, RGB, or in another bit resolution, for example, 32 bits, must be converted 11, 12 to grayscale and/or 8-bit resolution. Any conversion technique from the state of the art that meets these purposes can be used in the present disclosure. For example, the data can be scaled from 32-bit float data to 8-bit int data depending on the segmentation methods. For another example, the data can be spatially scaled with upsampling techniques (increased resolution and cubic/trilinear interpolation).

Optionally, the 8-bit resolution grayscale images can undergo another optional pre-processing of adaptive histogram equalization (CLAHE—Contrast Limited Adaptive Histogram Equalization), where the image (or seismic or outcrop data) has its contrast adjusted to facilitate the detection of fractures in non-uniform data that make it difficult to define global attributes.

### Second Step—Segmentation 2

Image segmentation is experimentally performed by three main techniques applied to 8-bit grayscale images. Any of the three techniques listed below can be used to carry out the present disclosure. As will be seen, the techniques mentioned below are known in the state of the art. The innovation introduced by the present disclosure occurs by the combination of Steps 1, 2, 3 and 4 based on two-dimensional slice images.

The first technique is based on pyramid smoothing 21 and adaptive thresholding 22. Pyramid smoothing 21 involves decreasing and increasing the scale (resolution) of an image. Depending on the number of levels, the image is more or less smoothed but maintaining the pixel resolution and helping to highlight larger faults and fractures. Adaptive thresholding 22 is a binarization segmentation separating objects of interest from background or secondary objects. This segmentation is done adaptively, that is, each pixel in the image has a threshold value T calculated given a window of predetermined size around each pixel. Then, a sketonization technique 25 is applied, ensuring that the outlines will be 1 pixel wide, which is necessary for the next step. The sketonization algorithms can be based, for example and without limitation, on Voronoi techniques, morphological operations of controlled iterative erosion (objects are eroded until they have a width of one pixel), and by medial axis transformation that measures all distances from an object to its edge (the pixels furthest from the edges are the central pixels).

The second segmentation technique 23 is based on the Hessian derivative filter (matrix of second partial derivatives) for the detection of valleys and peaks. The size of the filter is given by a sigma index that is the Gaussian aperture, and the peaks or valleys are given by the eigenvalues of the matrix resulting from the convolution of the filter on the image. Finally, a global thresholding is applied to extract the desired features. Then, the sketonization technique 25 mentioned above is applied.

The third technique is based on the Steger algorithm, which uses a matrix of second derivatives, but uses a post-processing step similar to that used by the Canny algorithm (non-maxima suppression) to detect valleys and peaks in an image. The non-maxima suppression process uses the directions of the gradients to identify the peak elements and keep only those elements that should have a width of 1 pixel. This technique does not require the skeletonization step 25, and can proceed directly to the next step.

### Third Step—Vectorization and Topology Extraction 3

This step consists of extracting the topological elements 31 and vectorizing the fracture network. To this end, a method composed of eight steps was developed, shown in FIG. 2. Step 1 is the convolution of a 3×3 filter over images with one-pixel-wide elements to demarcate pixels or sets of pixels that must be associated with nodes and terminations, counting the elements within the filter. Given the presence of a central element, how many additional elements are identified are counted: if there is only one more element, it will be a termination; if there are three more elements, it will be a Y node; if there are more than three elements, it will be an X node. From these pixels, a growth algorithm, step 2, is applied to extract the pixels that are part of each segment using the terminations and nodes as starting points: when the algorithm finds another node or termination, the growth is interrupted and the pixels belonging to a discontinuity are identified. In step 3, the pixels belonging to a segment or line are recorded in a matrix along with their ID and type. In step 4, the initial and final positions of the pixels of segments close to a node are identified. In step 5, the elements that reach a node region are extended to the average position of these points (centroid), while the segments are associated with the nodes to create the graph of the topological network. In step 6, the segments described so far are simplified pixel-by-pixel by applying the Douglas-Peucker algorithm, which uses the greatest distance in relation to the line from the initial to the final point to subdivide a delineation into larger segments. In step 7, meeting points are identified between pairs of segments in which the angle between them is smaller than a defined threshold, which is chosen after the consolidation of the topological network (step 6) or before starting the process, in order to add new termination points (I), where the preferred threshold is an angle smaller than 130°, but not limited to this. In step 8, the topological elements in I, Y and X are extracted, as well as the graph structure that defines the fracture network.

This step results in representative images of the segmented and vectorized fractures, facilitating the extraction of the topological network and sample statistics related to fracture intensity and connectivity.

### Fourth Step—Fracture Statistics 4

The last step of entire flow is the statistical analysis and generation of diagrams related to the fracture network, such as the generation of rosette diagrams, ternary topology diagrams, area sampling (square and circular) of intensity indexes (P21) and connectivity (Branch connections and hydraulic connectivity). Specifically, an algorithm for obtaining statistics from fracture networks 41 is executed, which provides one or more topological maps of fracture networks 42, ternary connectivity diagrams 43, sampling by area of intensity or connectivity 44, and adjustment of distributions 45.

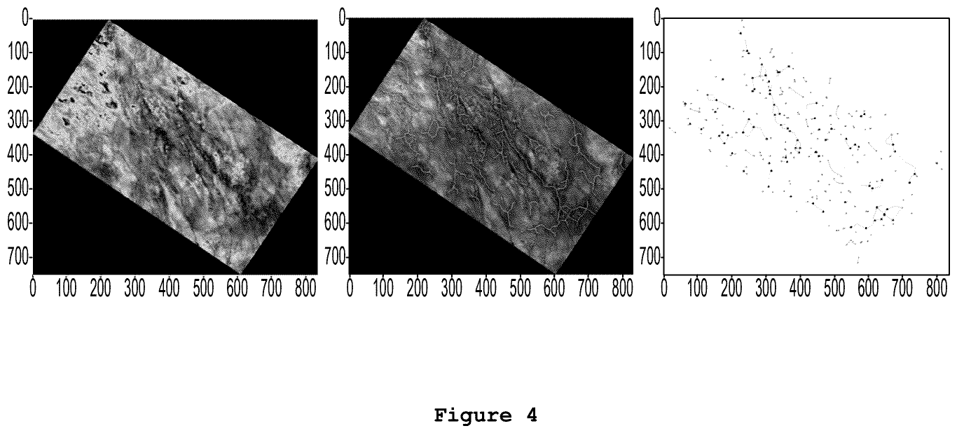

FIG. 4 briefly illustrates the results of steps 1, 2 and 3 above in sequence: first the pre-processing (loading and preparing the data), then the application of segmentation algorithms to obtain the profiles (central areas of the fractures) and then, the extraction of the topological network obtained from the algorithm developed for the vectorization of the fracture network.

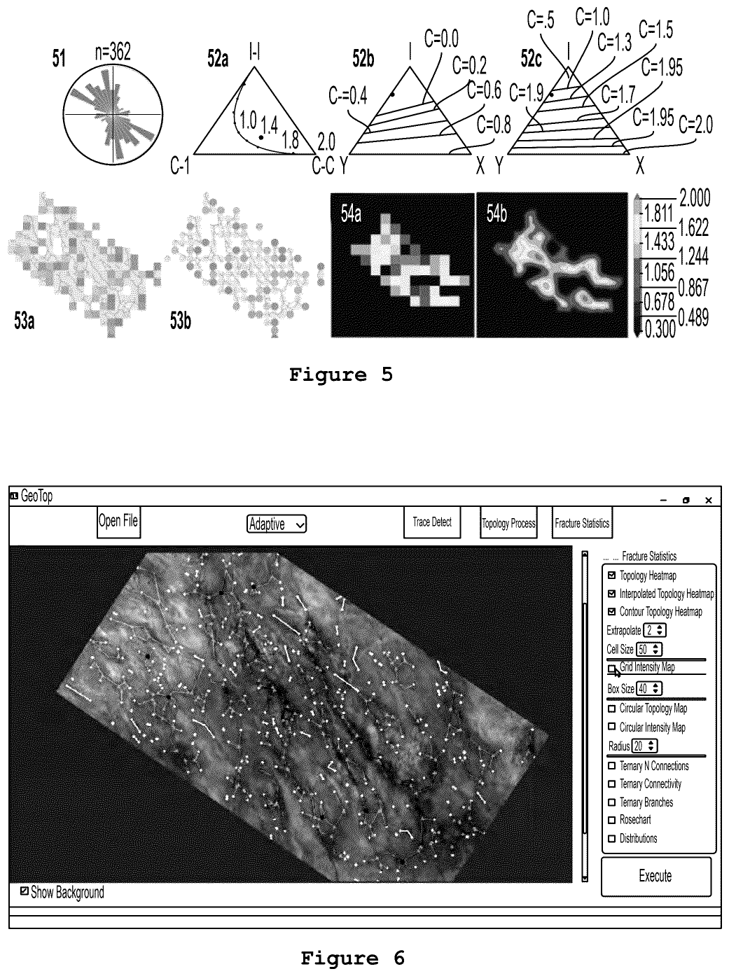

Examples of statistics, directional and by area, are shown in FIG. 5, highlighting: directional statistics (rosette) 51, ternary diagrams of ratio between types of junctions and types of branches 52a, 52b and 52c, intensity diagrams by box 53a and circular 53b, and connection diagrams by branch 54a and their interpolation in contour line 54b.

The present disclosure is preferably carried out in a computational environment in a way that allows user intervention/customization (called assisted mode). FIG. 6 illustrates an exemplary user interface that assists the user in customizing the process (based on the choice of methods that will be part of the workflow) by adjusting the parameters of computer vision methods such as sigmas (increasing or decreasing the level of segmentation detail) and the size of sample areas for computing fracture intensity and topology statistics.

In this way, the user visualizes the results of each of steps 1, 2, 3 and 4, and can change the pre-processing, segmentation or vectorization parameters, for example, in order to achieve more satisfactory results, such as: highlighting only the main fractures or extracting a more complex fracture network depending on what is to be highlighted in the seismic element. The automated processing of slices and the automatic extraction of statistics and diagrams relevant to reservoir characterization with the possibility of assisted processing is the main advantage of the present disclosure. As previously mentioned, manual processing is very time-consuming. Therefore, the professional, with the benefit of the present development, can dedicate himself to the analysis of a larger number of oil fields at the same time that it would previously take to evaluate only one field manually.

Furthermore, the fracture segmentation techniques employed by the present disclosure do not depend on prior learning and can be used for any type of slice image without restriction. However, there are no impediments when applying them to vertical sections.

Furthermore, the georeferencing information is respected, ensuring the superposition of the identified fractures on the input model (seismic or outcrop image).

Although aspects of the present disclosure may be susceptible to various modifications and alternative forms, specific embodiments have been shown by way of example in the drawings and have been described in detail in this document. But it should be understood that the disclosure is not intended to be limited to the particular forms disclosed. Rather, the disclosure is intended to cover all modifications, equivalents and alternatives that fall within the scope of the disclosure as defined by the following appended claims.

1. A computer-implemented method for segmentation and extraction of topological network of fractures in seismic attributes, the method comprising the steps of:
receiving two-dimensional images of slices;
performing segmentation (2) of the received images;
performing topology extraction of the segmented images; and
obtaining fracture statistics from the topology extraction.

2. The method according to claim 1, wherein the performing segmentation of the received images comprises one of:
pyramid followed by adaptive thresholding and followed by sketonization of the received images; or
edge detection by Hessian matrix and global thresholding followed by sketonization of the received images; or
valley detection by Steger algorithm.

3. The method according to claim 2, wherein the performing topology extraction (3) from the segmented images comprises executing a topological extraction algorithm (31), the algorithm performing the following steps:
Step 1: convolution of a 3×3 filter in a skeletonized image to demarcate pixels and a set of pixels that must be associated with nodes and terminations;
Step 2: applying a growth algorithm to extract the pixels that are part of each segment using as a starting point the regions of nodes and terminations identified in the previous step;
Step 3: identifying the pixels belonging to a segment or trace in a matrix associating each pixel of a trace with an id and type;
Step 4: identifying the beginnings and endings of the segments;
Step 5: extending the segments that reach a node to the average position of the points close to a node, in addition to associating the node id with the id of the segments that reach a node to create the graph or discretization of the topological network;
Step 6: applying the Douglas Peucker algorithm;
Step 7: identifying angles between pairs of segments smaller than a defined degree for the addition of termination points by adding these elements to the graph;
Step 8: extracting the topological elements in I, Y and X, analyzing the elements of the graph and connections between elements.

4. The method according to claim 3, wherein the obtaining fracture statistics (4) from the topology extraction (3) comprises obtaining statistics of fracture networks (41), wherein obtaining statistics of fracture networks (41) comprises obtaining one or more of topological maps of fracture networks (42), ternary connectivity diagrams (43), samples by area of intensity or connectivity (44), and adjustment of distributions (45).

5. The method according to claim 4, further comprising an optional pre-processing step (1) for performing pre-processing of the received two-dimensional slice images prior to the step of performing segmentation (2).

6. The method according to claim 5, wherein the performing pre-processing comprises one or more of transforming the received two-dimensional slice images to grayscale (11), transforming the received two-dimensional slice images to 8-bit resolution (12), and applying contrast monitoring (CLAHE—Contrast Limited Adaptive Histogram Equalization) (13).
